(19) United States
(12) Patent Application Publication
(10) Pub. No.: US 2004/0265075 A1
(43) Pub. Date: Dec. 30, 2004

(54) Cutting tool

(76) Inventor: Werner Kolker, Ratzeburg (DE)

Correspondence Address: VIDAS, ARRETT & STEINKRAUS, P.A., 6109 BLUE CIRCLE DRIVE, SUITE 2000, MINNETONKA, MN, 55343-9185, US

(21) Appl. No.: 10/832,671

(22) Filed: Apr. 27, 2004

(30) Foreign Application Priority Data
Apr. 29, 2003 (DE) 103 19 169.0

(51) Int. Cl. B23B 27/00

(52) U.S. Cl. 407/113

(57) ABSTRACT

A cutting tool with at least one cutting edge and adjacent to the cutting edge having at least one chip face and at least one flank face, wherein the chip face and/or the flank face have a coating using the PVD and/or the CVD process, characterized in that the surface of the coating of the flank face and the surface of the coating of the chip face have different microtopographic properties influencing the chip flow.

### CROSS-REFERENCE TO RELATED APPLICATIONS

Not applicable.

### STATEMENT REGARDING FEDERALLY SPONSORED RESEARCH

Not applicable.

### BACKGROUND OF THE INVENTION

A cutting tool typically comprises a cutting wedge with a cutting edge, a cutting face and a flank face. The cutting face frequently has special configurations for improved discharge or evacuation of the cuttings such as flutes, chip breaker features or the like, for example. As used in the following, surfaces, surface zones or the like mean principally those surfaces of the cutting wedge.

It is well known to coat cutting tools with a hard material, in order to improve the tool properties, especially in terms of its hardness and/or the frictional properties of the surfaces. It is well known that greater hardness reduces wear and results in longer service life of the tool. Relatively low surface roughness of the surfaces adjacent to the cutting edge improves chip flow and glide behavior. For example, TiN, TiAIN, Al₂O₃, TiCN, etc. may be considered as the coating material. Coating is conventionally done using the CVD or the PVD process. In the CVD process, at least one thin layer of metals such as, carbides, titanium carbides, chromium carbides, boron carbides, nitrides, etc., for example are deposited onto a substrate from a gas phase by means of chemical reactions such as, for example, thermal decomposition, at temperatures of from 500 to 1100° C. In the PVD process the coating is done by means of physical vapor deposition processes using plasma—activated methods under vacuum. In ion plating, an electrical voltage is applied to a conducting substrate in a vacuum chamber and in a first work step the surface is initially cleaned by bombardment with argon ions. In the second step, the coating material is vaporized and deposited on the surface. Using PVD, hard material layers can be deposited at substantially lower temperatures than in the CVD process.

Coating tools with more than one coating is well known from a number of U.S. Patents (U.S. Pat. No. 5,143,488, U.S. Pat. No. 5,250,362, U.S. Pat. No. 5,364,209, U.S. Pat. No. 5,750,247, U.S. Pat. No. 5,722,803 or U.S. Pat. No. 5,879,823). As used in the following, coating is understood to mean also multiple layers of same; in other words, the coating is comprised of a plurality of individual layers, which are sequentially applied. In the known process, a first coating is frequently applied in the CVD process and then a following coating is applied using the PVD process. All proposed processes have the intended purpose of improving the cutting characteristics and the stability of the tool.

JP 2 000 042 806 A, EP 109 94 132 A1 or DE 100 48 899 A1 describe providing so-called indicator layers in cutting tools, in particular in the case of cutting inserts. The indicator layers are, for example, applied to the flank. This is achieved in that initially a first coating of the complete tool is done using Al₂O₃, for example, and then application of a second coating onto a cutting insert, for example, is done over the entire surface. Then the second coating is removed approximately in the cutting face. This is not difficult, because the indicator layout has the desired property of being damaged or removed at the time of slight mechanical action.

DE 197 24 319 teaches a process for influencing the characteristics of chip flow from tool faces in the vicinity of the cutting edges in tools generating chips, wherein by means of a laser irradiation at least the chip faces in the vicinity of the cutting edge are provided with a surface structure having an altered geometric pattern. In this regard, application of layers having desired properties influencing chip flow by means of a laser beam is also included. In virtue of a specific directioning of the marking forming the pattern not only is the flow rate affected, for example, but also the direction of flow of the chips is also influenced.

The object of the invention is to provide a cutting tool, wherein the surfaces adjacent to the cutting edge, depending on stress, are optimized with regard to their characteristics.

### BRIEF SUMMARY OF THE INVENTION

In the cutting tool according to the invention, the surface of the coating of flank face has different properties with regard to the characteristics of chip flow in contrast with the surface of the cutting face. The term different property is intended to mean especially the friction value. Obviously, friction can be determined only with respect to a so-called frictional partner. The friction value of a surface is determined substantially by the roughness of the surface, which is in the 100 nm range in the case of a coating done using the CVD or PVD process and by the adhesive forces between the cooperating surfaces of the work piece and the tool. Generally, it is desirable that the flank face be made smoother or with less friction than the chip face.

Different processes are conceivable for adjusting or modifying the surfaces or the characteristics of chip flow. By way of example, the surfaces can be endowed with different a fabric structure and/or microtopography by means of specific laser irradiation or by means of specific thermal treatment. This can be the case if, for example, both the chip face and the flank face are provided with a complete but at least uniform coating on the surface and one of the surfaces is later modified in its microtopography by thermal or laser irradiation. An alternative possibility is to provide the chip face and the flank face with a first coating material on the surface and then to provide either the flank face or the chip face with a second coating material. Finally, it is also possible to provide the chip face and the flank face each with a separate coating material on their surfaces.

In an embodiment of the invention, the surface of the chip face and/or the flank face is provided with at least one limited surface zone. The surface zone has, in comparison with the rest of the surface of the chip face and/or the flank face, different properties with regard to the characteristics of chip flow. Accordingly, the surface friction of the surface zone can be greater or lower that that of the rest of the surface of the chip face and/or the flank face. According to one embodiment of the invention, the surface of the area section can be formed from a coating material other than that of the surface of the rest of the surface of the chip face and the flank face.

In the alternative, the surface zone can have a fabric structure and/or microtopography—in virtue of specific laser irradiation or thermal treatment of a surface of the coating of the chip face and/or flank face—which is different from the fabric structure and/or the microtopography of the rest of the surface of the chip face and the flank face.

According to another embodiment of the invention, a plurality of surface zones are provided, which form a homogeneous pattern parallel to the cutting edge. The pattern can be comprised of individual points, strips or the like, wherein the extent of the surface zones transverse to the cutting edge can be greater or smaller than those parallel to the cutting edge.

In the case of cutting inserts, which have four cutting edges arranged in a rectangle or rhombus, for example, the one cutting edge can be associated with a first surface pattern which is different from the surface pattern associated with the second cutting edge.

In several embodiments of the invention production of entire or partial surfaces of the chip face or the flank face by means of coating with a hard material layer, for example, using the PVD process on specific areas of the surface, on the flank face or on the chip face of the tool, for example, having optimized properties for the flank face or for the chip face.

Prior to treatment or coating of surfaces of the tool for obtaining specific surface characteristics or chip flow characteristics for the cutting process, the surface of the work piece can be pre-treated. Accordingly a whole or partial pre-coating of the surface can be done using the CVD process or the PVD process using a pre-defined material. Instead of a pre-coating, an alternative pre-treatment can be done by nitriding or boriding or using an alternative diffusion process, for example, which results in an alteration or an improvement of the structure in the superficial zone of the work piece.

When doing so, one can proceed so, that a first coating has optimized properties with regard to the chip face or the flank face. The second coating, which is applied only in the zone of the flank face or the chip face, optimizes the surface properties with regard to said surface area of the tool. It is also conceivable, on the basis of complete coating, to apply different second coatings for specific surface zones such as the chip face and the flank face, for example, in order to influence the cutting and chip flow characteristics as well as other parameters, for example, which determine the quality of the cutting tool, such as friction, hardness, etc. Of course, the fact remains, that in addition to the tool geometry essentially the material used for coating or the nature of the treatment (heat, laser irradiation, chemical treatment, etc.) are decisive for these properties.

At the time of coating, pre-defined first surface zones of the tool are covered, whereby only pre-defined second surface zones are provided with the coating or a surface pattern of coatings. For example, after pre-coating of a total or partial area with a first material, the tool is covered using a template, which has holes, openings, slits, patterns of slits or openings, which form the surfaces or surface patterns of two surface zones.

Performance of this process is relatively simple and rational. If, for example, the first coating is done using the PVD process, the second coating is also done using the PVD process, in that the targets are replaced in the coating chamber. If necessary, covering the tools can be done in the coating chamber. Preferably, however, application of the coverings of the tools is done outside of the coating chamber, because a batch is usually comprised of a number of tools, which are held in the coating chamber with the aid of a suitable carrier or holding structure.

In the PVD process, the work piece is an electrode and at least one target, which consists of the coating material, is represented by another electrode. In another process, use is made of the fact, that the electromagnetic field can be directed and/or influenced with the aid of suitable means and this for the purpose of coating only very specific surface zones with the coating material during the coating operation, wherein the work piece on the one hand is arranged in a suitable fashion and on the other the field is influenced in a specific fashion. In this connection it is also conceivable, to provide auxiliary electrodes, screens, masks or the like, which have characteristics influencing the field and simultaneously form a covering.

In a third process, use is made of the fact, that it is well known to move the work pieces to be coated along pre-defined paths in the coating chamber, so that the most uniform application is obtained. It is also well known for achieving the same purpose to arrange at least two targets in the coating chamber, whose direction of action is offset by approximately 90°. There is obviously a difference, whether one surface of the work piece in the coating chamber is turned facing the target or lies on the shadow side. By using targets with different materials, for example, and by means of an appropriate path of movement of the work pieces, specific surface zones of the work piece can be coated with one material and other surface areas can be coated with another material. To this end, not only the work pieces are moved along pre-defined trajectories but the targets are also optionally activated and deactivated in synchrony therewith, in order to achieve the desired result.

Using the described processes, an optimum layer for differently stressed surface zones of the tool can be easily achieved. Optimum property is defined approximately as the friction coefficient, the hardness (thermal hardness), diffusion coefficient, solubility, resistance to oxidation, resistance to wear, roughness, temperature stability, texture and the like. Accordingly, for example, the chip face can be coated with Al₂O₃ and the flank face with TiN. In the alternative, the chip face can be coated with TiAlN and the flank face with TiN. If the tool has a flute, its surface can be coated with a third coating. Overall, for example, TiN, TiCn, TiAlN, TiAlSiN, TiAlCN, Al₂O₃ or ZrO₂CrN, a-CH and the like can be used as coating materials.

In virtue of coating according to a pre-defined pattern, a specific topography can also be produced, in order to produce or to improve properties influencing chip flow.

The process according to the invention will now be explained in more detail with reference to exemplary embodiments represented in the drawings.

### DETAILED DESCRIPTION OF THE INVENTION

While this invention may be embodied in many different forms, there are described in detail herein a specific preferred embodiment of the invention. This description is an exemplification of the principles of the invention and is not intended to limit the invention to the particular embodiment illustrated

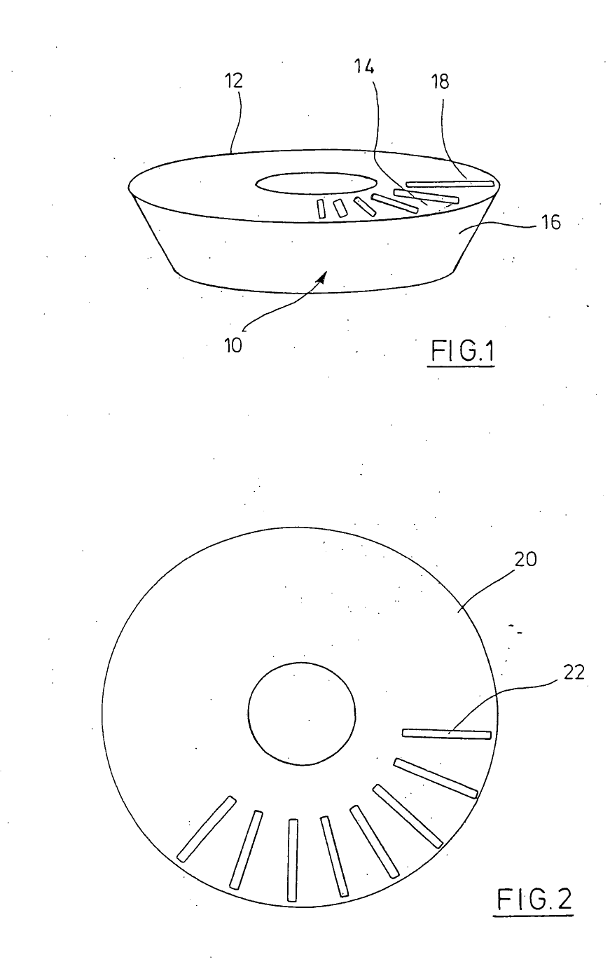

FIG. 1 represents a perspective view of a circular cutting insert having a coating according to the invention;

FIG. 2 represents a template for producing the coating of the cutting insert according to FIG. 1;

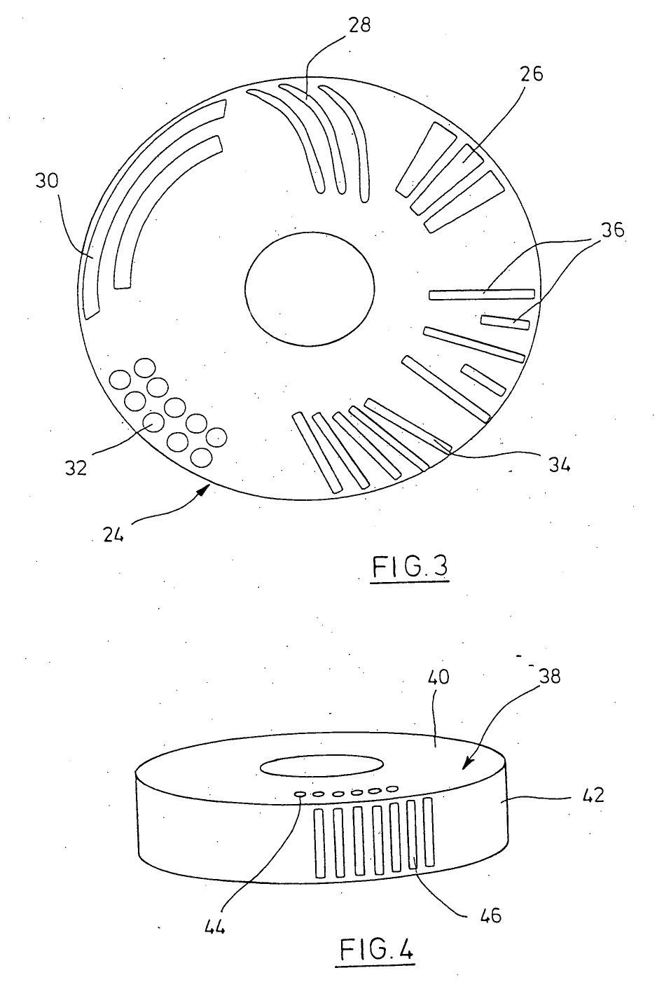

FIG. 3 represents a top view onto another embodiment of a disc template with different exemplary patterns;

FIG. 4 represents a perspective view of an cup template for producing a coating according to the invention;

FIG. 5 represents a perspective view of a milling cutter with an auxiliary electrode for a coating according to the invention;

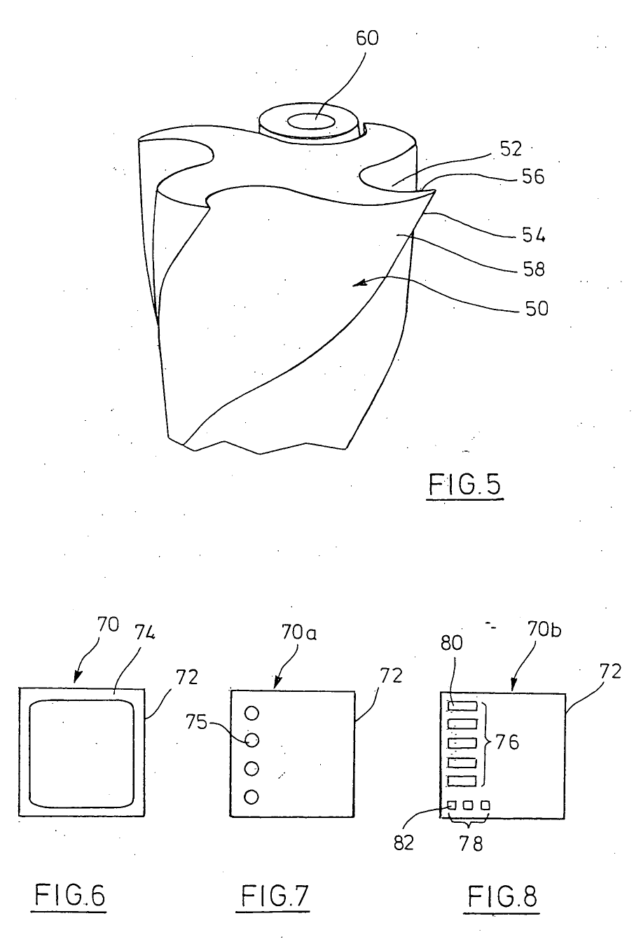

FIG. 6 to 8 represent top views onto Gottard cutting inserts according to the invention;

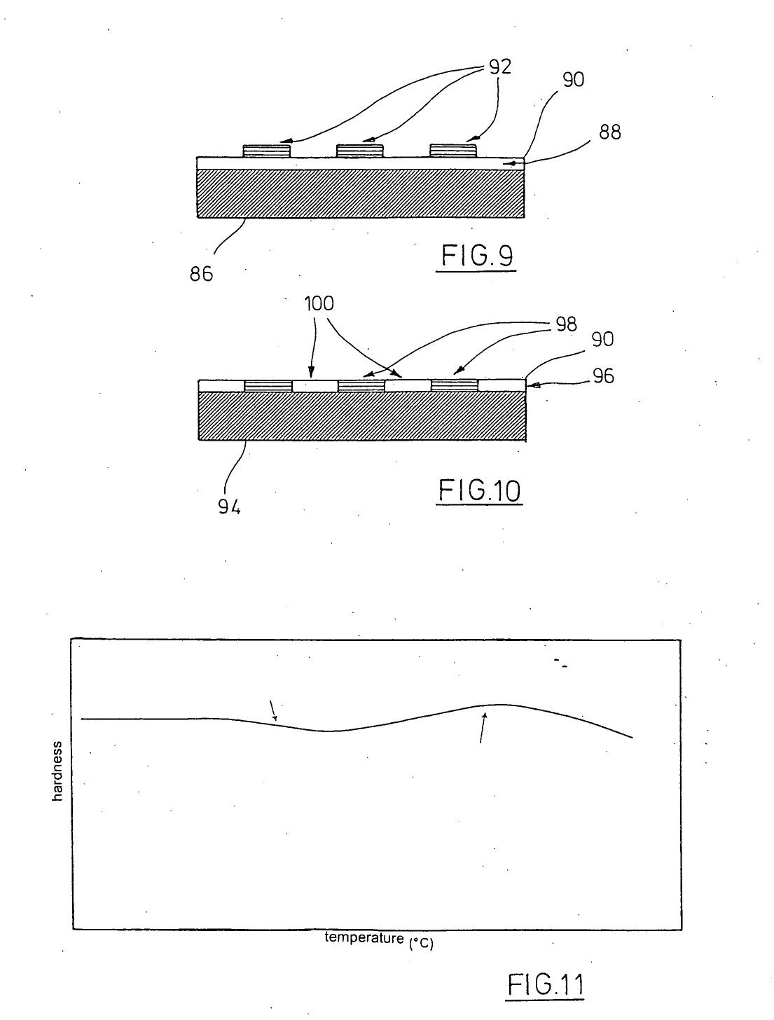

FIG. 9 represents a section through part of a cutting insert according to the invention;

FIG. 10 represents an illustration similar to that of FIG. 9 but with another coating;

FIG. 11 represents a hardness—temperature diagram.

FIG. 1 shows a cutting insert 10 with a circular cutting edge 12, which has a chip face 14 and a flank face 16. As can be see, on the chip face there is a pattern of radially separated strip-like layers 18. The cutting insert 10 is provided totally with a coating comprised of a suitable material in the CVD or PVD process; for example, with Al₂O₃ or with TiAlN. The strip-line coatings 18 are applied using another material but also in the PVD process and optimize the characteristics of the chip face, in that the coating 18 provides for an improved chip flow, for example.

FIG. 2 shows a circular template, with which the top surface of the cutting insert 10 is covered after the first coating operation, in order to make possible the strip-like coatings 18. For this purpose, the template 20 is provided with rectangular longitudinal radial slits 22. The slits 22 thus make it possible to coat the chip face 14 of the cutting insert 10 only in strip-like sections. In the coating process in a coating chamber (not shown) for the PVD process, the template 20 can be applied to the cutting insert 10 in appropriate fashion, by arranging it between the cutting insert when they in a stack one on top of the other in the coating chamber, for example.

FIG. 3 represents a circular template 24, similar to the template 20 in FIG. 2, having different slit patterns. At 26 trapezoidal slits, at 28 arcuate slits, at 30 concentric arcuate slits, at 32 a hole pattern, at 34 angled rectangular slits and at 36 radial rectangular slits of different lengths are shown. The individual slit patterns are intended only as examples. For the respective application, naturally, only one of the patterns are used for the entire template.

FIG. 4 represents an cup template, which can be placed on a cutting insert 10 according to FIG. 1. The circumference of the cut template 38 corresponds approximately to the circumference of the cutting edge 12. The cup bottom 40 consequently covers the chip face 14 and the wall 42 covers the flank face 16. It can be seen that the bottom 40 has a hole pattern 44 and the wall 42 has axially parallel rectangular slits 46. Hole patterns 44 and slits 46 are indicated only for a specific area but can extend over the entire periphery of the cup template 38. Using this type of cup template, therefore, a corresponding pattern can be produced in a second coating on the flank face 16 or on the chip face 14 of the cutting insert 10.

With reference to the examples of FIGS. 1 to 4, it is shown how, by means of suitable covering of specific surface zones, a second coating can be obtained using a suitable material for optimizing the function of the concerned surface. FIG. 5 represents a milling cutter 50 with a coiled flute 52, so that a coiled cutting edge 54, a coiled chip face 56 and a coiled flank face 58 are formed. An auxiliary electrode 60, which naturally also has a coiled shape, is arranged in one of the cutting members 52 shown. It covers the flute and the chip face but, in virtue of its electromagnetic field, it influences the flux lines between the milling cutter 50 and the target for coating using the PVD process in the coating chamber, so that here, for example, only the flank face is coated in suitable fashion with a material optimizing the function of the flank face 58.

The different coating materials, as used in the embodiment in FIGS. 1 to 5, are intended to optimize the properties of the chip face and the flank face. Of course, as regards the chip face other requirements than are imposed on the flank face. In addition, the optimum of the flank face and the chip face depends also on the work piece material, especially on the chip forming characteristics of the work piece material.

The pattern represented in FIGS. 1 to 4 can, instead of using an additional or other coating, be produced also in that specific surface sections are given other physical characteristics, wherein partial treatment is done using heat or using laser irradiation, for example. It is known that, depending on the temperature setting, thermal treatment results in a reduction in hardness because of the breakdown of latent stresses or in an increase in hardness in virtue of thermally activated deposition of nanoparticles, as is shown in FIG. 11. At mid-range temperatures from 400° C. to 600° C. there is a breakdown of latent stresses and at higher temperatures from 700° C. to 1,000° C. there is an increase in hardness. An increase in hardness in the high temperature range does not occur in all types of coating. It his, however, well known for so-called ALTIN layers. Here, it is a so-called spinodal decomposition reaction in the crystal lattice of the layer. The separations occurring therein—only several nanometers in size—result in a microscopic increase in hardness of the coating.

FIG. 6 shows a view from above onto a first squarish disposable cutting insert 70 having four cutting edges 72 and a peripheral chip face 74, which has other chip flow characteristics or friction values different from those of the flank face (not shown herein).

In the case of the squarish disposable cutting insert 70 a in FIG. 7 together with the cutting edges 72, a pattern comprised of circular surface sections 74 relative to a cutting edge is represented in a row almost parallel to and separate from the cutting edge. In the disposable cutting insert 70 b according to FIG. 8, together with the cutting edges 72 two patterns 76, 78 of flank segments 80 or 82 are. provided in row arrangement. The surface sections 80 form a uniform pattern parallel to the cutting edge 72 and separated from it, while the surface sections 82 form a uniform pattern parallel to the lower cutting edge and separated from it. The surface section shown in FIGS. 6 to 8 have other properties relative to the chip flow, which differ from the adjacent surface areas or the surface of the flank face (not shown), which naturally can also be provided with a desired surface pattern. As has already been mentioned, the surface sections 74, 75, 80 and 82 can be produced by means of an additional coating using a suitable coating material or by means of laser or thermal treatment, in order to generate the hardness, friction or other physical qualities affecting the characteristics of chip flow. This is shown somewhat more clearly with reference to FIG. 9 and 10.

In FIG. 9 a substrate 86, say a disposable cutting insert, is provided with a first coating 88, which can cover both the chip face and the flank face of the cutting wedge, for example. In FIG. 9, for example, the coating 88 is that of the chip face. The cutting edge is at 90, for example. As can be seen, a surface pattern 92 is formed by partial coating using a second coating material, whereby the coating material of the surface pattern 92 has other chip flow characteristics differing from those of the first coating 88. In addition, a height topography is produced. Obviously, each coating 88, 92 can be assembled from a number of individual layers.

In FIG. 10, a substrate 94, a disposable cutting insert for example, is provided with a single coating 96, which can again be comprised of a number of individual layers. In virtue of the specific treatment, particular surface zones are generated in part; accordingly, for example, the surface areas 98 and 100. The surface areas 100 are the same in terms of their properties as the originally applied coating material of the coating 96. In the surface areas 98, a specific temperature treatment by means of laser irradiation or the like, for example, is done, whereby a microtopographical material structure is generated. Accordingly, the surface areas 98 have properties that are different from the surface areas 100 with respect to the characteristics of chip flow of the tool.

The above disclosure is intended to be illustrative and not exhaustive. This description will suggest many variations and alternatives to one of ordinary skill in this art. All these alternatives and variations are intended to be included within the scope of the claims where the term “comprising” means “including, but not limited to”. Those familiar with the art may recognize other equivalents to the specific embodiments described herein which equivalents are also intended to be encompassed by the claims.

Further, the particular features presented in the dependent claims can be combined with each other in other manners within the scope of the invention such that the invention should be recognized as also specifically directed to other embodiments having any other possible combination of the features of the dependent claims. For instance, for purposes of claim publication, any dependent claim which follows should be taken as alternatively written in a multiple dependent form from all prior claims which possess all antecedents referenced in such dependent claim if such multiple dependent format is an accepted format within the jurisdiction (e.g. each claim depending directly from claim 1 should be alternatively taken as depending from all previous claims). In jurisdictions where multiple dependent claim formats are restricted, the following dependent claims should each be also taken as alternatively written in each singly dependent claim format which creates a dependency from a prior antecedent-possessing claim other than the specific claim listed in such dependent claim below.

This completes the description of the preferred and alternate embodiments of the invention. Those skilled in the art may recognize other equivalents to the specific embodiment described herein which equivalents are intended to be encompassed by the claims attached hereto.

What is claimed is:

1. A cutting tool with at least one cutting edge and adjacent to the cutting edge having at least one chip face and at least one flank face, wherein the chip face and/or the flank face have a coating using the PVD and/or the CVD process, characterized in that the surface of the coating of the flank face and the surface of the coating of the chip face have different microtopographic properties influencing the chip flow.

2. The cutting tool according to claim 1, wherein the surface friction of the chip face is greater or lower than that of the flank face.

3. The cutting tool according to claim 1, wherein the surface of the chip face and the flank face are formed from different coating materials.

4. The cutting tool according to claim 1, characterized in that the surface coating of the chip face and/or the flank face have a different fabric structure, hardness and/or microtopography in virtue of a specific laser irradiation.

5. The cutting tool according to claim 1, characterized in that the surface coating of the chip face and/or the flank face have a different fabric structure, hardness and/or microtopography in virtue of a specific thermal treatment.

6. The cutting tool according to claim 3, wherein the chip face and the flank face are coated using a first coating material and conversely the surface of the flank face and the chip faces is formed from a second coating material.

7. A cutting tool with at least one cutting edge and adjacent to the cutting edge having at least one chip face and at least one flank face, wherein a coating of the chip face and/or the flank face is provided using the PVD and/or the CVD process, characterized in that the surface of the chip face and/or the flank face has at least one limited surface section (74, 75, 80, 82) and the surface section, in comparison with the rest of the chip face and/or the flank face, has different chip flow characteristics.

8. The cutting tool according to claim 7, wherein the surface friction of the surface section (74, 75, 80, 82) is greater or less than that of the rest of the surface of the chip face and/or flank face.

9. The cutting tool according to claim 7, wherein the surface of the surface section (92) is formed from a coating material other than that of the rest of the surface of the chip face and/or the flank face.

10. The cutting tool according to claim 7, wherein the area section (98) has a fabric structure and/or microtopography in virtue of specific laser irradiation or heat treatment of a surface of a coating (96) of the chip face and/or the flank face, said fabric structure and/or microtopography being different from that of the rest of the surface.

11. The cutting tool according to claim 7, wherein a plurality of area sections (75, 80, 82) form a uniform pattern parallel to the cutting edge (72).

12. The cutting tool according to claim 11, characterized in that the extent of the area section (80) transverse to the cutting edge (72) is greater or smaller than that parallel to the cutting edge (72).

13. The cutting tool according to claim 7, wherein two adjacent cutting edges form an angle, wherein the first cutting edge is associated with at least one surface section (80) the second cutting edge with a second surface section (82), wherein the surfaces of the first and second surface sections (80, 82) are different in their contour, topography and/or in their chip flow characteristics.
